(19) United States
(12) Patent Application Publication
(10) Pub. No.: US 2025/0204560 A1
(43) Pub. Date: Jun. 26, 2025

(54) WHOLESOME SUGAR BEET DERIVED PRODUCT HAVING LIGHT COLOUR AND IMPROVED TASTE AND MOUTHFEEL AND METHOD OF MAKING THEREOF

(71) Applicant: SOCIETE DES PRODUITS NESTLE S.A., Vevey (CH)

(72) Inventors: LISA MARCELA LAMOTHE, Lausanne 26 (CH); SIMON LIVINGS, Savigny (CH); VINCENT DANIEL MAURICE MEUNIER, Epalinges (CH); PATRICIA MURCIANO MARTINEZ, Pully (CH); STEFAN PALZER, Lausanne 26 (CH); ANA ROVALINO, Epalinges (CH); SHEILA RUIZ BARBERO, Lausanne (CH); JEAN-CLAUDE DELASOIE, Lausanne 26 (CH)

(21) Appl. No.: 18/851,853

(22) PCT Filed: Mar. 31, 2023
(86) PCT No.: PCT/EP2023/058536

§ 371 Date: Sep. 27, 2024

(30) Foreign Application Priority Data
Mar. 31, 2022 (EP) 22166135.8
Oct. 21, 2022 (EP) 22202916.7

(51) Int. Cl. A23L 19/10

(52) U.S. Cl. CPC A23L 19/10

(57) ABSTRACT

The invention relates to a method of making a sugar beet derived product, said method comprising the steps of obtaining sugar beet pieces by peeling and cutting sugar beet; heat treating the sugar beet pieces; reducing the size of the sugar beet pieces; forming a sugar beet paste from the sugar beet pieces; and pasteurizing the sugar beet paste.

### INTRODUCTION

Sugar beet is commonly used for the extraction and purification of sucrose. The resulting side stream contains the fibrous portion of the root, commonly known as sugar beet pulp. Sugar beet pulp is currently used either for animal feed or is purified further for food grade applications.

Most sugar beet derived food products available on the market have a somewhat dark color, as well as earthy flavor notes, and a gritty mouthfeel. This limits their use in many food applications. The permanence of earthy notes and poor color are a result of the process applied, which often involves organic solvents.

There is a clear need to develop new wholesome sugar beet derived ingredient products which are more nutritious and sustainable, and have improved color, flavor, and mouthfeel properties.

### SUMMARY OF THE INVENTION

The inventors have developed a novel method of making a sugar beet derived product that is sweet, white, and mildly fruit flavored. The nutritious and sweet attributes of the raw sugar beets are preserved without the presence of unwanted bitter “earthy” off-notes or color changes.

The first step in the method involves the cleaning of raw sugar beets. Subsequently, heat treatment is applied to help eliminate the characteristic earthy, musty flavors of raw beets. One of the main contributors of these off-notes is geosmin, which is an odor metabolite produced by soil microorganisms. Organic solvents such as pentane have been used in prior art methods for extraction of geosmin. The present method omits the use of organic solvents and focuses on cleaning, heat treatment and optional peeling steps to significantly reduce the off-notes produced by the presence of geosmin. The method is very effective in minimizing the drawbacks generated by long storage. A reproducible flavor profile has been obtained independently of the sugar beet origin.

Several factors have been found to be involved in the formation of colored compounds during sugar beet processing, including the presence of an enzyme, polyphenol oxidase. The color formation mediated by enzymes is a fast reaction. In the case of sugar beets, it was observed to start within few minutes after cutting. The enzyme is labile to acidic pH and high temperature, and so the method includes a combination of both factors. One option is to immerse clean sugar beets in a solution at low pH (below 5). Subsequently, a heat treatment is applied to the sugar beet pieces to ensure that the enzyme is permanently inactivated. This is done, for example, by steam treatment. No color change is typically observed in the ingredient after processing.

Other factors related to color formation involve sugar degradation reactions where monosaccharides (mainly glucose and fructose) are responsible. Avoiding harsh thermal treatments under acidic conditions is, thus, one of the key factors to prevent sucrose degradation. Given the relatively mild heat treatment applied in the method, this ensures that no sucrose degradation is taking place. This is confirmed by the compositional analysis where sucrose content in the product closely resembles the amounts found in raw sugar beet. Furthermore, the optimized residence time and temperature conditions during drying prevents a darker color formation due to caramelization of sucrose.

### EMBODIMENTS OF THE INVENTION

The invention relates to a method of making a sugar beet derived product, said method comprising the steps of
a) Obtaining sugar beet pieces; and
b) Heat treating and reducing the size of the sugar beet pieces to form a sugar beet paste.

The invention further relates to a method of making a sugar beet derived product, said method comprising the steps of
a) Obtaining sugar beet pieces;
b) Heat treating the sugar beet pieces;
c) Forming a sugar beet paste from the sugar beet pieces; and
d) Pasteurizing the sugar beet paste.

In one embodiment, the sugar beet pieces are subjected to heat treatment. The heat treatment can be at least 60° C., preferably between 60 to 90° C. Optionally, the pH of the produced paste can be reduced. Optionally, an inert atmosphere could be applied to ensure enzyme inactivation.

The invention further relates to a method of making a sugar beet derived product, said method comprising the steps of
a) Forming a coarse paste;
b) Heat treating the coarse paste;
c) Reducing the particle size of the coarse paste; and
d) Pasteurizing the paste to form sugar beet paste.

The invention further relates to a method of making a sugar beet derived product, said method comprising the steps of
a) Obtaining sugar beet pieces by peeling and cutting sugar beet;
b) Heat treating the sugar beet pieces;
c) Reducing the size of the sugar beet pieces;
d) Forming a sugar beet paste from the sugar beet pieces; and
e) Pasteurizing the sugar beet paste.

In one embodiment, the sugar beet has been cut to form pieces having an average size of between 3 to 6 cubic centimeters.

In one embodiment, the sugar beet or sugar beet pieces are soaked in acid solution at between pH 2 to 5.

In one embodiment, the sugar beet pieces are heat treated, for example by steam treatment, to a temperature greater than 60° C., or at least 80° C., or at least 85° C., or at least 90° C., preferably between 70 to 110° C.

In one embodiment, the sugar beet pieces are heat treated, for example by steam treatment, to a temperature greater than 60° C., or at least 80° C., or at least 85° C., or at least 90° C., preferably between 70 to 110° C., for at least 15 minutes, or for at least 20 minutes, or for at least 40 minutes.

In some embodiments, wherein the reduction in size of the sugar beet pieces in step c) is performed under an atmosphere comprising over 80%, preferably over 90% nitrogen gas.

In some embodiments, the paste is subjected to enzymatic treatment or to bowl chopping for at least at least 20 min at about 80° C.

In one embodiment, heat treating the paste comprises heating to a temperature of at least 60° C., or at least 80° C., or at least 85° C., or at least 90° C., preferably between 70 to 110° C.

In one embodiment, the paste is heat treated for at least 15 minutes, or at least 40 minutes, preferably between 15 minutes to 2 hours, more preferably between 20 minutes to 45 minutes.

In one embodiment, geosmin is substantially absent from the sugar beet paste.

In one embodiment, the method comprises wet milling. In one embodiment, the method comprises bowl chopping.

In one embodiment, the method comprises enzymatic treatment of the sugar beet paste. In some embodiments, the enzymatic treatment comprises treatment with one or more of b-glucosidase, polygalacturonase, arabinase, arabinofuranosidase, xylanase, lytic polysaccharide monooxygenase and rhamnogalacturonase.

In one embodiment, the enzymatic treatment comprises treatment with b-glucosidase. In one embodiment, the enzymatic treatment comprises treatment with polygalacturonase. In one embodiment, the enzymatic treatment comprises treatment with arabinose. In one embodiment, the enzymatic treatment comprises treatment with arabinofuranosidase. In one embodiment, the enzymatic treatment comprises treatment with xylanase. In one embodiment, the enzymatic treatment comprises treatment with lytic polysaccharide monooxygenase. In one embodiment, the enzymatic treatment comprises treatment with rhamnogalacturonase.

The enzymatic treatment may be performed at a pH range between 3.5-5. The enzymatic treatment may be performed at temperatures between 40-60° C. The enzymatic treatment may be performed for between 1 to 6 hours.

The use of enzymatic treatment surprisingly allows the solubilization of fibers into the liquid making it more homogeneous and reducing its viscosity.

In one embodiment, the method does not use organic solvents, for example alcohols.

In one embodiment, the sugar beet paste undergoes a roller drying step.

In one embodiment, the sugar beet paste is further concentrated until it has a total solids content of between 15 to 30%, more preferably 20 to 30%, most preferably 25 to 30%.

In one embodiment, the sugar beet paste undergoes a crystallization step.

In one embodiment, the crystallization step comprises water evaporation. In one embodiment, the crystallization step comprises seeding with crystalline sucrose.

In one embodiment, the crystallization step comprises water evaporation and seeding with crystalline sucrose.

In one embodiment, the sugar beet paste is subjected to a cavitation step. In one embodiment, the cavitation step is a hydrodynamic cavitation step.

In one embodiment, the method further comprises the step of preparing sugar beet flakes from the sugar beet paste, preferably using a drying step, wherein the sugar beet flakes have a moisture content of up to 2.5%.

In one embodiment, the method further comprises the step of preparing sugar beet flakes from the sugar beet paste, preferably using a drying step, wherein the sugar beet flakes have a bulk density of at least 0.42 g flakes per cubic centimeter.

In one embodiment, the method further comprises the step of preparing sugar beet flakes from the sugar beet paste, preferably using a drying step, wherein the sugar beet flakes have a tapped density of at least 0.64 g flakes per cubic centimeter, wherein the flakes have a D50 particle size between 2 to 4 mm, and a D90 particle size between 5 to 10 mm.

In one embodiment, the drying step is roller drying or convective drying or vacuum drying, preferably roller drying.

In one embodiment, the method further comprises the step of preparing a sugar beet powder from the sugar beet flakes, preferably by grinding or dry milling, wherein the sugar beet powder has a moisture content of up to 2.5%.

In one embodiment, the method further comprises the step of preparing a sugar beet powder from the sugar beet flakes, preferably by grinding or dry milling, wherein the sugar beet powder has a bulk density of at least 0.35 g powder per cubic centimeter.

In one embodiment, the method further comprises the step of preparing a sugar beet powder from the sugar beet flakes, preferably by grinding or dry milling, wherein the sugar beet powder has a tapped density of at least 0.45 g powder per cubic centimeter, wherein the powder has a D50 particle size between 25 to 30 microns, and a D90 particle size between 150 to 200 microns.

In one embodiment, the viscosity of the sugar beet powder after reconstitution in water is at least 10 mPas when measured at a shear rate of 10 1/s at 20° C.

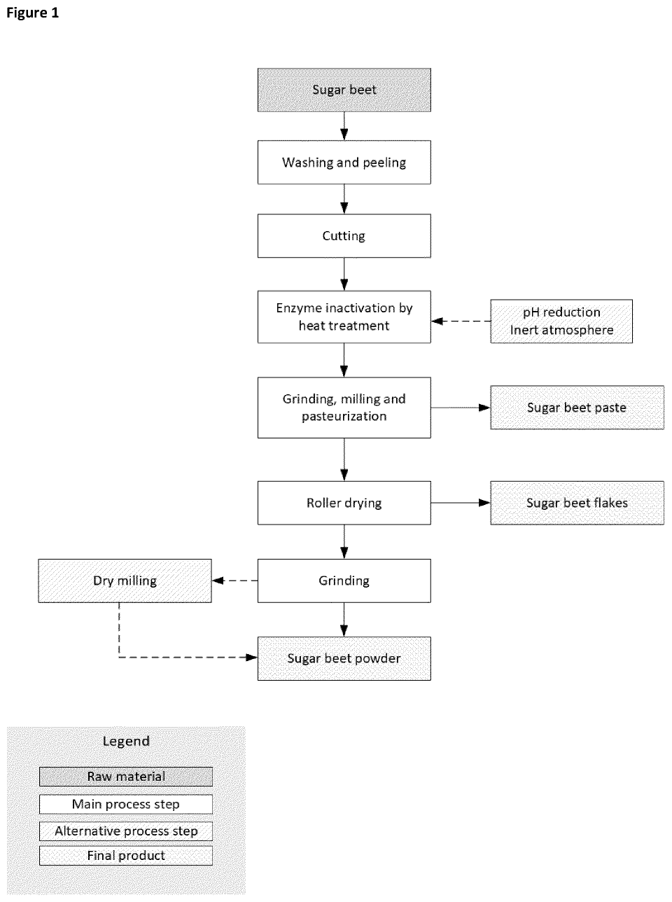

In one embodiment, the method of making the sugar beet paste product is substantially as shown in FIG. 1. In one embodiment, the method of making the sugar beet flake product is substantially as shown in FIG. 1. In one embodiment, the method of making the sugar beet powder product is substantially as shown in FIG. 1.

In some embodiments, the sugar beet can be substituted by sugar cane.

The invention further relates to sugar beet paste, or sugar beet flakes, or a sugar beet powder product made according to the method of the invention.

The invention further relates to a sugar beet powder product, wherein said powder product has
a. Whiteness Degree (WD) greater than 90; and/or
b. A moisture content of less than 2.5 wt. %; and/or
c. A geosmin content of less than 0.05 mg/g, preferably about 0.01 mg/g.

The invention further relates to a food or beverage product comprising the sugar beet paste, or sugar beet flakes, or sugar beet powder product according to the invention.

The invention further relates to a food or beverage product comprising the sugar beet paste, or sugar beet flakes, or sugar beet powder product according to the invention.

For example, the sugar beet paste can be used in liquid applications. For example, the sugar beet paste can be used in dry mixes for example cakes, sauces. The food product could be, for example, cereal bars, confectionery products, porridge, sauces, for example ketchup, baked products, for example bread, biscuits, and the like.

The food product could be a dairy or plant-based product.

The beverage product could be, for example, cocoa drinks, RTD products, and the like.

### DETAILED DESCRIPTION OF THE EMBODIMENTS

### Sugar Beet Pieces

Typically, the sugar beet product is made from sugar beets which have been harvested within the previous 3 months. No negative effects were seen on flavor when using sugar beet up to this age. If peeled and cut, the sugar beet derived product should preferably be made in a minimal time frame to prevent compromising the color of the ingredient. Preferably, a preliminary peeling step is performed.

Soil may be entrapped in the sugar beet due to its irregular shape. Peeling ensures that it is safe for consumption. The peeling step can be done manually, by abrasion or by applying steam for a very short time. After peeling, pieces should preferably not be exposed to oxygen for longer than about few minutes. During the waiting time from one step to another, both the entire sugar beets and the sugar beet pieces are soaked in water at low pH, for example at between pH 2 to 5, preferably pH 2 to 3.

Typically, the sugar beet is peeled and cut between 1 to 2 weeks after harvest. The sugar beet pieces have typically an average size of between 3 to 6 cm³.

### Enzyme Inactivation

An enzyme inactivation step, for example an oxidase inactivation step, can be performed. Enzyme inactivation can be performed, for example, by (i) applying steam treatment or other heat treatment to the sugar beet pieces. Preferably, steam treatment is at a temperature greater than 60° C., or at least 80° C., or at least 85° C., or at least 90° C., for at least 15 minutes, or for at least 20 minutes, or for at least 40 minutes. Sufficient steam should be used to prevent the pieces from becoming dried.

### Method of Making Sugar Beet Paste

The invention relates to a method of making a sugar beet derived product, said method comprising the steps of:
a) Immersing sugar beet pieces in acidic medium; and
b) Grinding the sugar beet pieces to form a sugar beet paste.

The method may further comprise the steps of:
a) Cutting sugar beet to form sugar beet pieces;
b) Heat treating the sugar beet pieces;
c) Grinding the sugar beet pieces whilst heating to form a sugar beet paste.

The method may further comprise the steps of:
a) Cutting sugar beet to form sugar beet pieces, wherein the sugar beet is preferably washed and/or peeled;
b) Heat treating the sugar beet pieces for example, by steam;
c) Grinding the sugar beet pieces whilst heating, and preferably by simultaneously mixing at low pH, preferably below 5, preferably between 2 and 3, or with inert gas, for example nitrogen gas, to form a sugar beet paste.

The sugar beet pieces can be heat treated for example, by steam treatment, at a temperature of at least 60° C., preferably between 8° and 90° C., for at least 15 minutes, preferably between 20 to 40 minutes. This step is done to ensure that the enzyme is permanently inactivated. The sugar beet paste may be prepared from the sugar beet pieces by grinding the sugar beet pieces whilst heating, for example to a temperature of at least 60° C., preferably between 60 to 90° C. Heating is preferably performed whilst mixing. Typically, the heating time is at least 15 minutes, preferably between 15 minutes and 2 hours. Typically, there is a simultaneous mixing with inert gas. The heating time usually depends on, for example, whether there is use of inert gas, the pH level, and/or if increased atmospheric pressure or vacuum is applied. The heating step is applied for tissue softening and intrinsic enzyme inactivation. The inert gas used can be, for example, nitrogen, argon, carbon dioxide, nitrous oxide or hydrogen. Preferably, the inert gas is nitrogen.

### Method of Making Sugar Beet Flakes

Sugar beet flakes can be prepared from the sugar beet paste by using a drying step. Preferably, the sugar beet paste is heated to about 80° C. before drying. The drying step is typically roller drying, for example at a roll temperature of about 160° C. Steam may be injected at about 6 bar. The drying step may alternatively be drying by vacuum oven or drying by convection oven. Typically, vacuum drying involves drying samples under vacuum in trays for 48 hours at 40° C. and 50 mbar. Typically, convection drying involves drying samples in a convection oven in trays at 80° C. for 12 hours.

The drying step increases the stability of the material when compared to freeze drying. Hygroscopicity is improved compared to that of amorphous sucrose. The presence of fibers in the ingredient contributes to the ingredient's stability by serving as a barrier or spacer to avoid close contact between sucrose molecules.

### Sugar Beet Flake Characteristics

The sugar beet flake product of the invention may have one or more of the following characteristics: (i) a T_{g} of about 52.7° C., (ii) a_{w} of about 0.11, (iii) a D50 of between 2-4 mm, (iv) a D90 of between 5-10 mm, (v) a bulk density between 0.35 to 0.45 g/cm³, and/or (vi) a tapped density between 0.6 to 0.7 g/cm³. Typically, 90% of the sugar beet flakes reconstitute in 18s at 20° C. Typically, the wettability time of the sugar beet flakes in water is 9s at 20° C.

### Sugar Beet Powder Characteristics

The sugar beet powder product of the invention may have between 1 to 4% protein, between 1 to 4% ash, between 75 to 85% total sugars, and between 10 to 20% dietary fiber, wherein the dietary fiber is made up of between 5 to 9% soluble fiber and between 5 to 11% insoluble fiber.

The sugar beet powder product of the invention may have about 2.3% protein, about 2% ash, about 79% total sugars, and about 15.6% dietary fiber (made up of about 6.8% soluble and about 9% insoluble).

The sugar beet powder product may have one or more of the following characteristics: (i) a T_{g} of between 40 to 50° C., or about 45° C.; (ii) a_{w} of less than about 0.08; (iii) D50 of between 15-40 μm, or between 25-30 μm; (iv) D90 of between 100-250 μm, or between 150-200 μm; (v) a bulk density of between 0.30 to 0.40 g/cm³, or about 0.35 g/cm³, and/or (vi) a tapped density of between 0.40-0.55 g/cm³, or about 0.48 g/cm³.

Typically, the sugar beet powder product has a geosmin content of less than 0.05 mg/g. This is the threshold value above which it is possible to perceive the earthy notes. Preferably, the geosmin content is about 0.001 mg/g.

Typically, the sugar beet powder has a residual polyphenol oxidase activity less than 4% of that found in the initially harvested sugar beet.

The sugar beet powder has a distinctive appearance. Typically, the sugar beet powder has one or more of the following characteristics: (i) a L* of about 95, (ii) an a* value of about −0.46, (iii) a b* value of about 4.7, and/or (iv) a Whiteness Degree (WD) of greater than 80, or greater than 90, or about 93. The L*, a*, b*, and WD can be measured according to methods as described herein.

Typically, 90% of the sugar beet powder product reconstitutes in about 39 s at 20° C. Typically, the wettability time of the sugar beet powder product in water is about 130 s at 20° C.

The sugar beet powder also has a distinctive appearance in aqueous solution. Typically, the sugar beet powder has one or more of the following characteristics in aqueous solution at 5 wt. %: (i) a L* of about 47, (ii) an a* value of about −1.46, (iii) a b* value of about −2.5, and/or (iv) a Whiteness Degree (WD) of about 47.

### Definitions

“Fresh sugar beet” means that the sugar beet has been peeled or cut less than 2 weeks after harvest, for example between 1 to 2 weeks after harvest. Sugar beet up to 3 months post-harvest can be used without significant effect on flavor.

“Acidic medium” means a liquid which has a pH less than 7 and comprises an acid, for example hydrochloric acid. Other acids that might be used in an acidic medium include citric acid, phosphoric acid or acetic acid.

As used herein, the singular forms “a,” “an” and “the” include plural unless the context clearly dictates otherwise.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

The compositions disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive. Any embodiment disclosed herein can be combined with any other embodiment disclosed herein unless explicitly stated otherwise.

As used herein, “about” and “approximately” are understood to refer to numbers in a range of numerals, for example the range of −20% to +20% of the referenced number, for further example the range of −10% to +10% of the referenced number, preferably within −5% to +5% of the referenced number, more preferably within −1% to +1% of the referenced number, most preferably within −0.1% to +0.1% of the referenced number.

The invention will now be illustrated by way of examples, which should in no way be thought to limit the scope of the invention as herein described.

### EXAMPLES

### Example 1

### Method of Making the Sugar Beet Product

An outline of the method of making the sugar beet product of the invention is shown in FIG. 1.

Sugar beet was first washed with cold water to remove remaining sand from the raw material. A knife and a peeler were then used to remove the outer layer or the skin of the sugar beet. This was found to contribute to the removal of “earthy” notes characteristic of these roots which are present mainly in the peel. Afterwards, the sugar beet was cut in pieces between 3 to 6 cm³ and the pieces are washed again to make sure there was no remaining sand or skin. Sugar beet pieces were steam treated at a temperature of 80° C. for 30 minutes to prevent the enzymatic browning due to polyphenol oxidase.

A solution of water, optionally at low pH, was then added to the sugar beet pieces. After water addition, the total solids of the paste represent between 17 to 25%. The pH of the water solution can be lowered with HCl until a pH between 2.5 to 3 was obtained. This was done to further prevent enzymatic browning due to polyphenol oxidase in the roots during grinding. The production was performed in batches of 60 kg (sugar beet pieces+water) where the material was placed in a bowl chopping device. This has the advantage of being able to mill and pasteurize at the same time, thus making the process more efficient compared with a milling device. Typically, the bowl chopper comprises 6 knifes. Preferably, the knives rotate at a speed of about 3000 rpm. This provides a very fine particle size within a short period of time. Pasteurization can be done simultaneously, for example by steam injection. This could be for at least 20 min at about 80° C. This step removes significantly the geosmin component. A shorter time of about 2 minutes at a temperature of at least 72° C. may also be used. This is sufficient for just a pasteurization step. Nitrogen can be added in the bowl chopper to provide an inert atmosphere.

The paste was then collected and dried in a drum dryer, in which the temperature and the thickness of the drying paste was adjusted to assure water evaporation without caramelizing the product, i.e. to avoid darkening of the ingredient. Hence, the steam injected to the roller dryer was set to 6 bar to obtain a temperature of the roller dryer of 160° C. and the paste flow was fixed at 10 to 15 kg per hour. The output of the roller dryer was a thin layer (between 1.2 to 1.7 mm) of dried sugar beet that could easily be smashed with the hand, producing sugar beet flakes. These sugar beet flakes could then be ground and dry milled to target lower particle sizes, e.g. for a powder.

### Example 2

### Properties of Sugar Beet Powder

Table 1 shows colorimetry of the dry powder as well as powder dissolved in water at a concentration of 5 wt. % that confirms that the WD of the powder is at least 90 without addition of acid.

| | Dry | Wet powder |
|---|---|---|
| | powder | Dispersion 5 wt. % |
| L* | 92.8 | 88 |
| a* | −0.05 | 0.18 |
| b* | 6.1 | 22.3 |
| C* | 6.1 | 22.3 |
| h | 90.5 | 89.5 |
| WD | 90.56 | 74.67 |

### Example 3

### Additional Method Steps

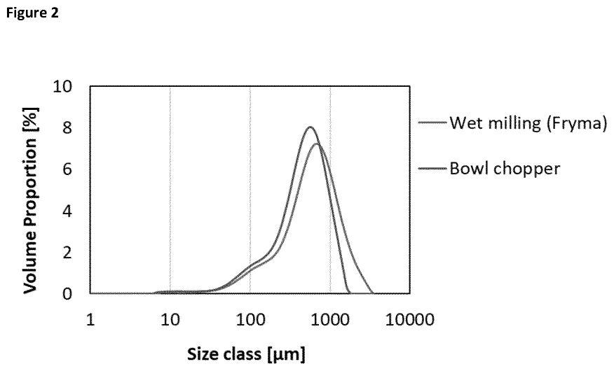

During the bowl chopping step, addition of water was found to aid the reduction in particle size distribution. A similar particle size distribution can be obtained at the same TS % when the wet milling and a bowl chopper are used for this type of fibers, facilitating significantly the process (FIG. 2).

After the bowl chopping step, additional steps can improve the properties of the sugar beet powder:

Nitrogen atmosphere: Nitrogen is flushed in the head space to assure a N₂ atmosphere and prevent darkening of the sugar beet due to the enzymatic activity.

Cavitation: A hydrodynamic cavitation step is added after the bowl chopping to modify the structure of the fibers, aiming to functionalize the insoluble fiber fraction of the ingredient and improve its suspension capabilities when dissolved. This step involves passing the paste through a rotor with cavities, so that when the rotor spins, microscopic cavitation bubbles are produced, and as they collapse, shock waves are given off into the liquid in a controlled manner for mixing, breaking down and heating.

Concentration: Prior to drum drying, the paste undergoes a concentration step to increase the TS of the paste and achieve a higher throughput during drying. However, insoluble fibers present in sugar beet have a high water-holding capacity. This increases the viscosity dramatically and limiting the flowability of the mixture at TS above 25-30%. For reaching higher TS, an enzymatic treatment is applied to reduce the size of the fibers and in turn their water-holding capacity. This treatment also increases the soluble/insoluble ratio of the fiber mixture.

Crystallization: In order to increase the stability of the final powder, the sugar present in the previously concentrated paste is crystallized. This is done in-situ while drying the paste in the roller drier and will be achieved by water evaporation and seeding with crystalline sucrose.

Co-drying with another ingredient: To increase the effectiveness of the drying, sugar beet paste can be mixed together with another ingredient, for example cocoa pulp, prior to the application of a conservative drying method. This confers the necessary homogeneity to the paste and prevents the addition of extra amounts of water because the sugar beet ingredient is already providing it.

Use of paste as final ingredient: The ingredient could be used as a paste for liquid applications such as RTD (provided that the small particle sizes are reached during bowl chopping) but also for certain confectionery or savory applications. This allows the elimination of the drying step, thus reducing the price of the final product. In addition, the paste could be added to the wet mix and then dried into a powdered beverage.

Use of enzymes: To increase the effectiveness of the drying, sugar beet paste can be enzymatically treated prior to the application of a conservative drying method. This reduces the water holding capacity of the fibers and prevents the addition of extra amounts of water improving the total solid content. For this purpose, a mixture of b-glucosidases, polygalacturonases, arabinases, arabinofuranosidases, xylanases, lytic polysaccharide monooxygenases and rhamnogalacturonases are used. The enzymatic treatment was performed at a pH range between 3.5-5 and temperatures between 40-60° C. for a period of time ranging from 1-6 h.

### Example 4

### Measurement Methods

Glass transition temperature (T_{g}) was measured by Differential Scanning Calorimetry (TA Instrument Q2000). A double scan procedure was used to erase the enthalpy of relaxation and get a better view on the glass transition. The scanning rate was set to 5° C./min. The system was then cooled at 20° C./min. The glass transition was detected during the second scan and defined as the onset of the step change of the heat capacity. The uncertainty of the measure was typically ±3° C.

Water activity (a_{w}) was measured by AquaLab 4TE Decagon (Decagon Devices Inc., US) following the ISO-18787 method. The measurement is based on the detection of dew on the mirror when the sample has the same RH and temperature as the headspace of the measurement chamber. The measurement is recorded every 5 minutes. The water activity is the average of the last 15 minutes when the differences between water activities are below 0.001. The water activity accuracy from duplicates is ±0.007. Measurements were performed at 25.0° C. (±0.1° C.).

Moisture content (M %) was determined using thermo-gravimetry analysis by using TG-DTA (Mettler Toledo GmbH, Switzerland AG) or by Q600 (TA Instruments, US), using the method described in Food Chemistry 2010, 122: 436-442. It recorded the mass loss of any homogeneous material upon constant heating rate and under controlled dry gas flow conditions. Each sample of 25 mg (±5 mg) was submitted to a heating rate of 2° C./min from 25° C. to 180° C. under dry nitrogen flow (100 mL/min). STARe ver. 11 software from Mettler-Toledo or TA Universal is used to analyze the TGA data for moisture content determination. The moisture content in g/100 g was the average of duplicates, with an uncertainty of 5%.

Dry particle size distribution was measured by Camsizer XT (Retsch Technology GmbH, Germany) by using dynamic image analysis of the dispersed powder. Powder was dispersed in a dry dispersion unit with an atomizing pressure of 120 kPa. Characteristic particle size D10, D50 and D90 are calculated from normalized curves, corresponding to the particle size of 10%, 50% and 90% of the particles number respectively. The values reported are D50 and D90. The uncertainty is of 10 μm for the D90 in the range of particle size of the powders.

Bulk and tapped density were measured with the Granupack (GranuTool Belgium) by recording the packing kinetics. A known amount of powder was inserted in a tube of fix diameter to remove sample handling variability. The tube was then tapped with a height of 1 mm and 500 taps and the volume of powder was recorded after each tap until the end of the experiment. The bulk density was calculated by using the initial volume of powder, whereas the tapped density was calculated by using the final value.

The color of the dry powder when dissolved in water at a total solid content of 5% was measured using DigiEye “DigiPix” system. Samples were placed in a closed, light controlled, environment and are photographed by a calibrated camera. Photos are treated by DigiEye V. 2.61 software and colorimetric data, L*, a*, b* are extracted. Where L* is the CIELAB lightness value, a* the CIELAB Red+/Green− value and b* the CIELAB Yellow+/Blue− value. The whiteness degree (WD) was calculated according to SOP-0261.01 using following equation:

$$WD = 100 - \sqrt{{( 100 - {L}^{*} )}^{2} + {a}^{{*}^{2}} + {b}^{{*}^{2}}}$$

Sugar concentration can be measured by high Performance Anion Exchange Chromatography (HPAEC). Extraction of sugars in water using sonication and injection on the HPAEC-PAD system. Neutral sugars being weak acids are partially ionized at high pH and can be separated by anion exchange chromatography on a base stable polymeric column. Sugars are detected by measuring the electrical current generated by their oxidation at the surface of a gold electrode and quantified by comparison with an external standard. Protein content can be measured according to standard AOAC procedure. Dietary fiber, in the form of total, soluble and insoluble dietary fiber can be measured according to standard AOAC procedure. Ash content can be measured according to the standard AACC procedure on Ash Basic Method.

Geosmin content was analyzed by GC-MS, in an Agilent 8890 GC coupled to an 7010B GC-TQ. The column used was a DB-WAX (60 m×250 μm×0.25 μm). The injector temperature was 230° C., and the splitless mode was used. The conditions were as follows: starting temperature 35° C. (holding 10 min), then raised to 250° C. at the rates of 4° C./min. SPME was done using PDMS/DVB 1 cm, 65 um (Supelco ref: 57345-U) with incubation time of 10 min and a temperature of 30° C. The desorption and extraction time was 10 min each. MSD analysis was done using the following parameters: 250° C., 10 Psi, Helium as the quench gas 2.25 mL/min and Nitrogen as collision gas 1.5 mL/min. The mass selective detector with quadrupole analyzer was operated in the electron ionization (El) mode. The temperature of ion source and quadrupole was 230° C. The ions (m/z) selected for the monitoring of geosmin were 97 (quantifier) and 83 (qualifier).

1. A method of making a sugar beet derived product, said method comprising the steps of
a) Obtaining sugar beet pieces by peeling and cutting sugar beet;
b) Heat treating the sugar beet pieces;
c) Reducing the size of the sugar beet pieces;
d) Forming a sugar beet paste from the sugar beet pieces; and
e) Pasteurizing the sugar beet paste.

2. The method according to claim 1, wherein the sugar beet or sugar beet pieces are soaked in acid solution having a pH between 2 to 5.

3. The method according to claim 1, wherein the sugar beet pieces are heat treated.

4. The method according to claim 1, wherein the reduction in size of the sugar beet pieces in step c) is performed under an atmosphere comprising over 80%, preferably over 90% nitrogen gas.

5. The method according to claim 1, wherein the sugar beet paste is subjected to a cavitation step.

6. The method according to claim 1, wherein the sugar beet paste is further concentrated until it has a total solids content of 25 to 30%.

7. The method according to claim 1, wherein the sugar beet paste undergoes a crystallization step.

8. The method according to claim 1, wherein the crystallization step comprises water evaporation and seeding with crystalline sucrose.

9. The method according to claim 1, wherein the sugar beet paste undergoes a roller drying step.

10. The method according to claim 1, further comprising the step of preparing sugar beet flakes from the sugar beet paste using a drying step, wherein the sugar beet flakes have a moisture content of up to 2%; and a bulk density of at least 0.42 g flakes per cubic centimeter.

11. The method according to claim 1, further comprising the step of preparing a sugar beet powder product from the sugar beet flakes by grinding, wherein the sugar beet powder has
a. A moisture content of up to 2.5%;
b. A bulk density of at least 0.35 g powder per cubic centimeter; and
c. A tapped density of at least 0.48 g powder per cubic centimeter, and the powder has a D50 particle size between 25 to 30 microns, and a D90 particle size between 150 to 200 microns.

12. The method according to claim 11, wherein said sugar beet powder product has
a. A Whiteness Degree (WD) greater than 90;
b. A moisture content of less than 2 wt. %; and
c. A geosmin content of less than 0.05 mg/g.

13. (canceled)

14. A sugar beet powder product, wherein said product has 1 to 4% protein, 1 to 4% ash, 75 to 85% total sugars, and 10 to 20% dietary fiber, wherein the dietary fiber is made up of 5 to 9% soluble fiber and 5 to 11% insoluble fiber.

15. (canceled)
